(19) United States
(12) Patent Application Publication
(10) Pub. No.: US 2023/0297076 A1
(43) Pub. Date: Sep. 21, 2023

(54) AUTOMATIC CONCEPTUAL PLANNING PROCESS, AUTOMATIC CONCEPTUAL PLANNING TOOL AND USAGE OF THE PROCESS

(71) Applicant: Siemens Aktiengesellschaft, München (DE)

(72) Inventors: Stephan Grimm, München (DE); Giray Havur, Wien (AT); David Michaeli, Tel Aviv (IL); André Scholz, Deining (DE); Sanjeev Srivastava, Chantilly, VA (US)

(21) Appl. No.: 18/020,091

(22) PCT Filed: Aug. 14, 2020
(86) PCT No.: PCT/EP2020/072924

§ 371 Date: Feb. 7, 2023

(51) Int. Cl. G05B 19/4155

(52) U.S. Cl. CPC G05B 19/4155; G05B 2219/31372

(57) ABSTRACT

A method for automatically determining of a changed manufacturing process of a product with changed manufacturing process data, including providing basic data which include historical manufacturing process data of at least one historical manufacturing process of the product, historical product data of the product, target manufacturing process data of a planned manufacturing process or target product data of a planned product classifying the basic data determining the changed manufacturing process with the aid of the classified data, wherein the providing, the classifying, and/or the determining of the changed manufacturing process is carried out with the aid of graph technology. In addition to the method, an apparatus with a computer system for carrying out of the method is provided. The computer system includes at least one insighter engine for the executing of the method and the insighter engine includes at least one data providing tool for providing of the basic data.

### CROSS-REFERENCE TO RELATED APPLICATIONS

This application claims priority to PCT Application No. PCT/EP2020/072924, having a filing date of Aug. 14, 2020, the entire contents of which are hereby incorporated by reference.

### FIELD OF TECHNOLOGY

This following relates to a method for automatically determining of a changed manufacturing process and an apparatus with a computer system for automatically determining of a changed manufacturing process. The method is an automatic conceptual planning process. The apparatus with the computer system is an automatic conceptual planning tool (automatic conceptual planning assistant). Moreover, the following relates to a usage of the method and usage of the computer system, respectively.

### BACKGROUND

Changes in products cause changes in production processes (changed manufacturing process). These changes can influence resources for the production process, too. In manufacturing domains, it is a frequently occurring planning step to adapt existing plants with established processes (historical manufacturing processes with historical manufacturing process data) and resources to new or changed products. Depending on the product and depending on the product manufacturing process the adaption to a changed process can require much effort.

### SUMMARY

An aspect relates to limit the effort which is required by the adaption of a manufacturing process of a product.

Further aspects of embodiments of the invention are the providing of a computer system for carrying out the method and a usage of the method.

With embodiments of the invention, a method for automatically determining of a changed manufacturing process of a product with changed manufacturing process data is provided. The method uses an apparatus with a computer system. With the method following steps are carried out:
providing of basic data which include historical manufacturing process data of at least one historical manufacturing process of the product, historical product data of the product, target manufacturing process data of a planned manufacturing process or target product data of a planned product;
classifying of the basic data for getting classified data;
determining of the changed manufacturing process with the aid of the classified data; wherein
the providing of the basic data, the classifying of the basic data and/or the determining of the changed manufacturing process is carried out with the aid of graph technology.

The method is an automatic conceptual planning process. With the method a changed conceptual manufacturing process can automatically defined. By the adaption of the changed manufacturing process to an existing (historical) manufacturing process the determining of the changed manufacturing can easily be executed.

In addition to the method, an apparatus with a computer system for carrying out of the method is provided. The apparatus with the computer system is a conceptual planning tool (conceptual planning assistant). The computer system comprises at least one insighter engine for the executing of the method and the insighter engine comprises at least one data providing tool for providing of the basic data. With the computer system an automatically determining of the changed manufacturing process with changed manufacturing process data can be conducted.

Moreover, a usage of the method (and hence a usage of the computer system) for determining the changed process is provided. The method is applicable for diverse businesses. In an embodiment, the determined process is an industrial process. In an embodiment, a changed process of the automotive industry is determined. The method is used for the automotive industry.

The basic data form a data basis for the method. The historical data are previous (former) data. For example, the historical manufacturing data are former (e.g., established) manufacturing data. The target data are the data of a planned manufacturing process and/or the data of a planned product.

The basic data comprise the manufacturing process data and/or the product data and/or product specification data and/or product design data. These data reflect historical conceptual plans and/or target conceptual plans. By that, the basic data can comprise every kind of data. In an embodiment, basic data with three-dimensional basic data are used. The three-dimensional data can refer to the historical product, to the target product, to the historical manufacturing process and/or to the target manufacturing process. With the aid of the three-dimensional data, the reality can be reflected resulting in a realistic changed manufacturing process. The determined changed manufacturing process is very close to reality.

The classifying of the basic data is a kind of typecasting of the basic data. By the classifying the basic data are structured.

With the aid of the graph technology a Knowledge Graph (KG) is generated. The graph technology comprises a semantically lifting of the basic data with the help of an ontology.

In an embodiment, at least one of following bills is used:
a bill of processes (BoP) specifying the historical manufacturing process data and/or the target manufacturing process data,
a bill of resources (BoR) specifying resources of the historical manufacturing process data and/or resources of the target manufacturing process data and
a bill of materials (BoM) with material elements of the historical product and/or with material elements of the target product.

Starting from a historical (existing) bill at least one new bill is generated and/or at last one historical (existing) bill is transformed into a new (changed) bill. For instance, a new BoM with new manufacturing process data is generated which addresses new requirements of a new (planned) manufacturing process.

In an embodiment, for the determining of the changed manufacturing process an identifying of similarities between the historical manufacturing data and the target manufacturing data and/or an identifying of similarities between the historical product data and the target product data is conducted. A similarity check is carried out. Additionally, in order to make the similarity check more efficient similarities between different historical data can be identified, too.

In an embodiment, for the identifying of similarities at least one of following similarity scoring methods is carried out: Eigenvector Distance (ED), Graph Edit Distance (GED) and Mean Levenshtein Distance of Graph Labels (MLD). The Eigenvector Distance is based on a topological similarity metric. The Graph Edit Distance focus on structural similarities. With Levenshtein Distance of Graph Labels semantic similarities by the distance between the labels in the given graphs are evaluated. In order to improve the similarity check two or all three similarity scoring methods are used.

In an embodiment, for the identifying of the similarities a change object list of changes between the historical manufacturing process data and the target manufacturing process data and/or between the historical product data and target product data are generated. By the identifying of similarities, the method can be performed efficiently and fast.

In an embodiment, an effort list, a risk list and/or a cost list of the changed manufacturing process are generated. For instance, this can be conducted based on the change object list.

In an embodiment, for the determining of the changed manufacturing process following additional steps are conducted:
generating of a preselected list with preselected manufacturing processes and
selecting of the changed manufacturing process from the preselected list with preselected manufacturing processes are executed.

For instance, based on the effort list, the risk list and/or the cost list a list of preselected manufacturing processes is generated. By that a ranking of alternative manufacturing processes is possible. This would result in a ranked list of alternative manufacturing processes with alternative BoM and BoP.

In an embodiment, a machine learning tool (ML) is used. The computer system comprises a machine learning tool. With the aid of the machine learning tool an automatic (e.g., iterative) approach for the determining of the changed manufacturing process is possible. This is very efficient by the combination with the graph technology.

The advantage of embodiments of the invention can be summarized as follows:
A conceptual planning of a process including effort, cost and risk estimation concerning the state of the conventional art is created by hand (mainly in Excel) by specialists. This conceptual planning is very effortful, error prone and time consuming. With embodiments of the invention, the conceptual planning of changed processes (the processes can be complex) can be very efficiently conducted.
The conceptual planning of changed processes result in less errors in comparison to the conceptual planning of changed processes concerning the state of the conventional art.

### BRIEF DESCRIPTION

Some of the embodiments will be described in detail, with reference to the following figures, wherein like designations denote like members, wherein:

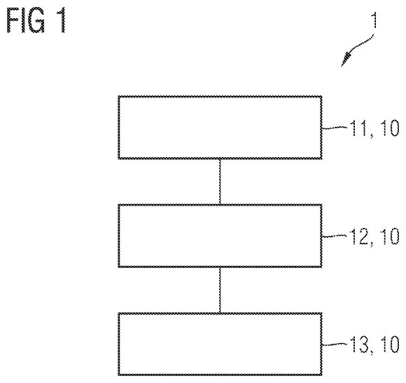

FIG. 1 shows the method;

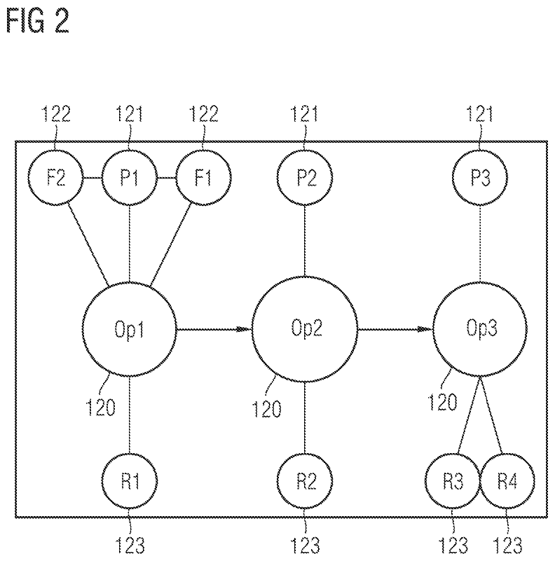

FIG. 2 shows a structure of a Knowledge Graph (KG);

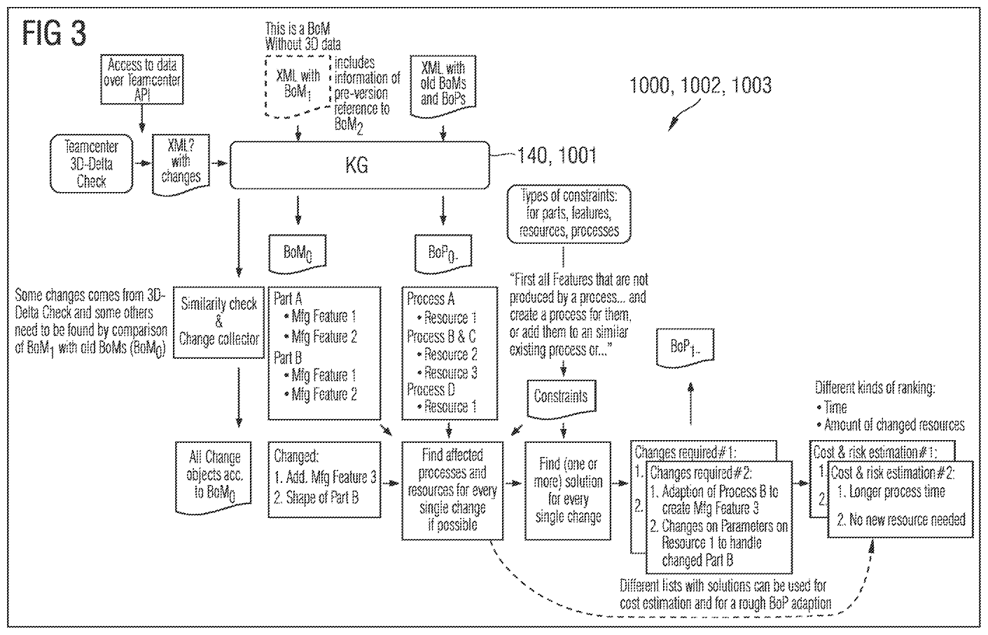

FIG. 3 shows a workflow for cost and risk estimation with the help of Knowledge Graph;

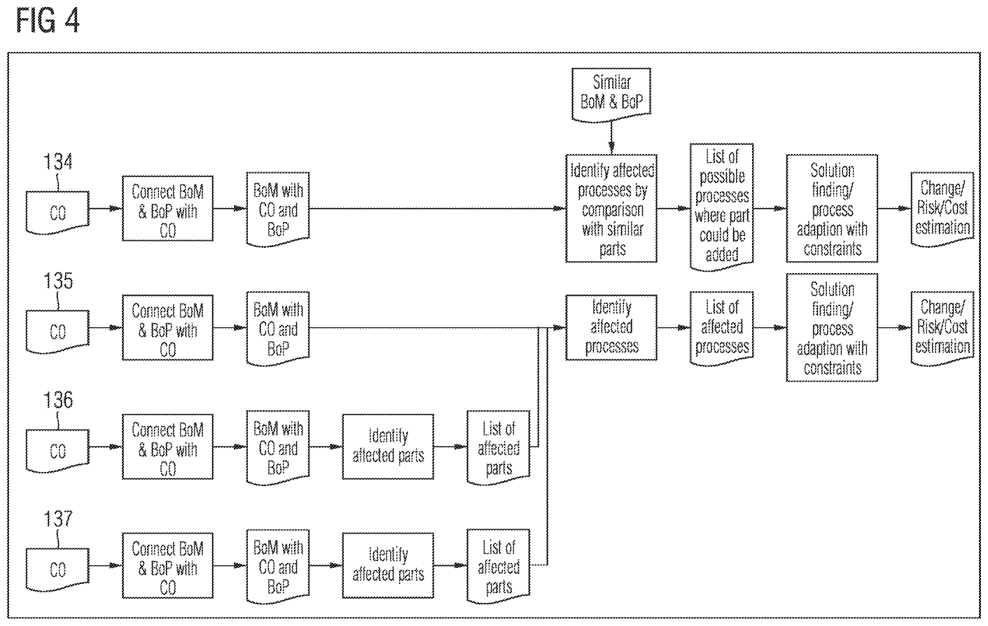

FIG. 4 shows possible changes as change objects (CO) from BoM with effects on corresponding BoP; and

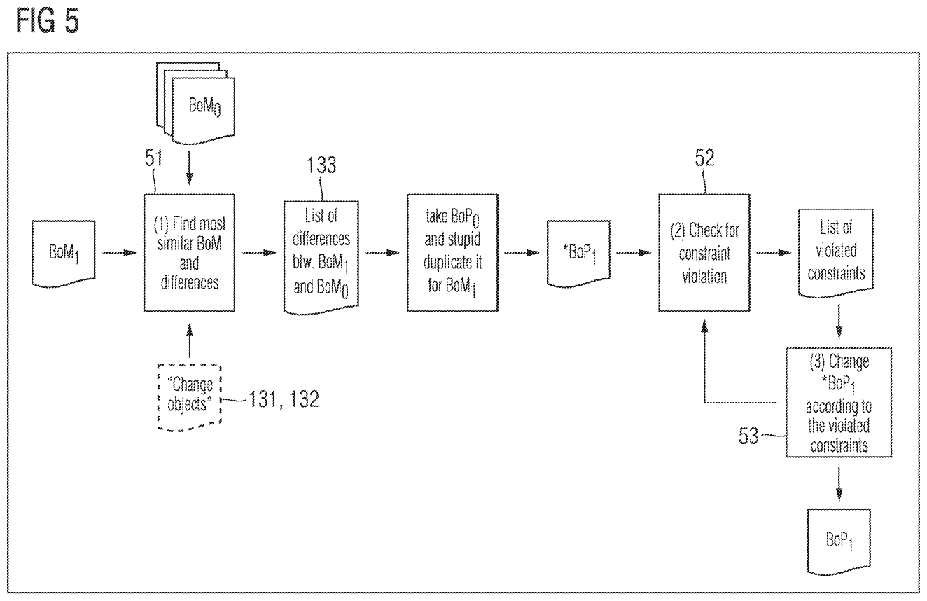

FIG. 5 shows the finding of the most similar BoM to BoM₁ and its respective BoP₁.

### DETAILED DESCRIPTION

The method is an automatic conceptual planning process. The used apparatus with a computer system is an automatic conceptual planning tool (automatic conceptual planning assistant). The conceptual planning tool 1000 is equipped with a machine learning tool 1002. The method is applied in the automotive industry.

For the method following steps are carried out (FIG. 1): Providing 11 of basic data which include historical manufacturing process data of at least one historical manufacturing process of the product, historical product data of the product, target manufacturing process data of a planned manufacturing process or target product data of a planned product, classifying 12 of the basic data for getting classified data and determining 13 of the changed manufacturing process with the aid of the classified data. The providing of the basic data, the classifying of the basic data and/or the determining of the changed manufacturing process is carried out with the aid of graph technology.

Besides the method aa apparatus with a computer system 1000 for executing of the method is described (FIG. 3).

For the providing of the basic data historical manufacturing process data and product data are used to create a Knowledge Graph. Out of these data a lot of domain knowledge, like the connection between different manufacturing features and their corresponding processes and resources is derived.

In addition, these data are lifted semantically with help of an ontology of the graph technology. After lifting the data from different sources in the Knowledge Graph, the structure of the data and its interconnections could look like in FIG. 2. Here one can see the operations 120 (Op1, Op2 and Op3) performed by several resources 123 (R1, R2, R3 and R4). These operations could be structured in a hierarchical way, to model also very complex operations and sub-operations of whole manufacturing process. The different operations work on parts (P1, P2 and P3) of the product, by creating manufacturing features (F1 and F2) or even handle them.

The Knowledge Graph 140 is used as data storage unit 1001 of historical (old) project data. With the help of this “historical” knowledge about products and their corresponding processes a prediction of a changed (new) BoP is available. This is possible, if a new BoM comes into the workflow, as described in FIG. 3 in detail.

The new BoM contains for example a new version (e.g., facelift) of an already produced car. In such a case the number of changes in the respective BoM is relatively small in comparison to the total amount of parts and manufacturing features. In order to find these changes (e.g., differences between a “new” BoM₁ and a nearly similar “old” BoM₀) already existing BoMs and their corresponding BoPs are analyzed. For this analyzing, an identifying of similarities between the historical manufacturing data and the target manufacturing data and an identifying of similarities between the historical product data and the target product data are conducted. A similarity (Delta) check is carried out.

For the identifying of the similarities a change object list 131 of changes between the historical manufacturing process data and the target manufacturing process data and a change object list 132 between the historical product data and target product data are generated. Hence, a list 133 of differences between BoM₁ and BoM₀ is generated. All changes and/or differences can be exported as a list together with the new BoM₁. The new BoM₁ can also include some information about the pre-version of the BoM. This can be done during the setting of the individual new BoM₁.

In an alternative embodiment, the changes between two BoMs can be identified after the setting of a number of new BoMₓ by comparison as follows:
a. The most similar BoM_{X} to BoM₁ is identified with a similarity check.
b. All differences between the “old” BoM₀ and the new BoM₁ are listed.

With the change information (every change is handled as Change Object (CO) with specific attributes) an adaption of the “old” BoP₀ can be performed, so that it fits to the new BoM₁. For every single change a rough estimation of effort, risk and cost can be created. For this, one needs to know which effect every single change produces in the BoP. By this, an effort list, a risk list and/or a cost list of the changed manufacturing process are generated.

To reduce the solution space of effects to the BoP one can create types of typical changes in the respective domain. Again, the information is structured. The raw data based on the BoPs are classified. In the Body-in-white-domain (e.g., in automobile manufacturing area: The BiW-domain is the stage in which a car body's frame has been joined together) there could be occur only a small number of senseful changes on a BoM. These lists can be created together with domain experts.

A list of possible change types is shown in FIG. 4: New part 134, changed part 135, new feature 136 and changed feature 137. For each of these change types there is also only a small number of possible changes that needs to be performed on the corresponding BoP to fit to the new BoM.

As example one could pick the introduction of a new additional part in the new BoM₁. This is the most difficult case of the Change Objects, because the new part is not yet connected to an existing process. In this case it is difficult to say, which process is affected by the change like in the other cases. This problem is solved again with the KG. The historic information in the KG is useful to find a similar part in the old projects. This part is connected to some processes. This could be a used as a possible solution: If these processes are also in the BoP₀ the new part could connected to these processes. If not, one needs to check, if there some similar processes or create a new process to handle the new part.

Another solution leads over new or changed features. These features are already connected to some parts and processes. In these cases, it is easier to find the affected processes to adapt them according to the Change Objects.

Given a BoM₁, all the existing BoM₁ in KG are ranked with respect to an aggregated similarity metric devised so that BoMₓ, BoMₓ₊₁, BoMₓ₊₂, . . . , BoM_{y} are ranked from the most similar BoMₓ to the least similar BoM_{y} to BoM₁. The goal is obtaining the list of similar BoMs to BoM₁. So, a generating of a preselected list is carried out. To achieve this preselected list of ranked BoMs, results from three different similarity scoring methods are aggregated for each BoM₁ and BoMᵢ pair: A topological similarity metric called Eigenvector Distance (ED), a structural similarity metric called Graph Edit Distance (GED), and A semantic similarity score that evaluates the distance between the labels in the given graphs named Mean Levenshtein Distance of Graph Labels (MLD). The similarity check is depicted with reference 51 in FIG. 5 represents this procedure.

For computing the ED value between two BoMs, the Laplacian eigenvalues for the adjacency matrices of each of the graph representations of the two BoMs in the KG are calculated. For each graph, the smallest k is found such that the sum of the k largest eigenvalues constitutes at least 90% of the sum of all the eigenvalues. If the values of k are different between the two graphs, then the smaller one is used. The similarity metric is then the sum of the squared differences between the largest k eigenvalues between the graphs. The ED values of two BoMs are in the range [0, ∞), where values closer to zero are more similar.

GED is a scalar measure that identifies the minimum number of operations to transform the graph representation of BoM₁ to a graph representation of BoMᵢ. The set of elementary graph edit operators typically includes vertex and edge insertions, deletions, and substitutions.

The Levenshtein distance between two words is the minimum number of single-character edits (insertions, deletions or substitutions) required to change one word into the other. MLD is a total minimum number of single-character edits between all the labels in the graph representation of BoM₁ to a graph representation of BoMᵢ.

Finally, these three similarity values between the BoM₁ and all the existing BoMᵢ in KG are aggregated and normalized to create the list of similar BoMs.

With the next step an adaption of a BoP given Change Objects and Domain Constraints is carried out.

After obtaining the list of similar BoMs, the BoP of the most similar BoM is selected from the list and duplicated as *BoP₁. The task “adaption of *BoP₁ to BoP₁” is represented by the references 52 and 53 (FIG. 5). The adaption comprises the steps a.) and b.):
a.) Adaption of a *BoP1 given Change Objects.

The features from the change objects are used to derive requirements regarding the first step of the adaption necessary to derive BoP₁ from *BoP₁. Such requirements enable to query the KG for obtaining the BoP fragments (a series of operations) to process the new parts in the change objects. These BoP fragments are intelligently integrated in *BoP₁ when necessary. Following notes: It could be possible that some requirements are already satisfied in *BoP₁. In addition, when a complete adaptation cannot be applied in *BoP₁, a new *BoP₁ is selected from the preselected list of BoMs and hence of the preselected list of BoPs. So, to approach to the changed manufacturing process the adaption can be done in an iterative way.

In order to integrate the process fragments into *BoP₁, the existent precedence constraints of operations in all BoPs in KG are reviewed. This automated process is successful when:
there are consecutive operations in *BoP1, namely Op1 preceding Op2,
Op1 is followed by the initial operation of a BoP fragment, and
the final operation of a BoP fragment if followed by Op2.
b.) Validation of BoP₁ using domain constraints.

Finally, *BoP1 is tested against the domain constraints for validation and repair. These domain constraints represent the typical violations in BoPs, and they are collected with the help of a domain expert. An example constraint c1 would be “load operation must not be followed by an unload operation”.

Such constraints are represented by a state-of-the-art language called SHACL (Shapes Constraint Language) for describing and validating RDF (Resource Description Framework) graphs. It can be used to define classes together with constraints on their properties. The language consists of several built-in types of constraints such as cardinality (minCount/maxCount), value type and allowed values, but it is also possible to define more complex kinds of constraints for almost arbitrary validation conditions (SHACL was accepted as a W3C (Word Wide Web Consortium, international standards organization) recommendation in July 2017). To perform a validation test, the validation engine must be given the graph representation of *BoP1 against the graph representing constraints.

The validation engine returns the fragments of *BoP1 which are not satisfying the constraints. As a last step, these fragments are attempted to be automatically repaired using the knowledge in the constraint. For example, given c1, in case there is an operation sequence where a load operation is followed by an unload operation in BoP1, the unload operation is removed, and the resultant *BoP1 is validated once again to check against side effects of this modification. If this process ends successfully with no violated constraints, the resultant BoP₁ is created (cf. FIG. 5).

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for automatically determining a changed manufacturing process of a product with changed manufacturing process data wherein the method uses an apparatus with a computer system and wherein the method comprises:
providing basic data which include historical manufacturing process data of at least one historical manufacturing process of the product, historical product data of the product, target manufacturing process data of a planned manufacturing process or target product data of a planned product;
classifying the basic data for getting classified data;
determining the changed manufacturing process with an aid of the classified data;
wherein the providing of the basic data, the classifying of the basic data, and/or the determining of the changed manufacturing process is carried out with an aid of graph technology.

2. The method according to claim 1, wherein basic data with three-dimensional basic data are used.

3. The method according to claim 1, wherein at least one of following bills is used:
a bill of processes specifying the historical manufacturing process data and/or the target manufacturing process data,
a bill of resources specifying resources of the historical manufacturing process data and/or the resources of the target manufacturing process data, and
a bill of materials with material elements of the historical product and/or with material elements of the target product.

4. The method according to claim 1, wherein, for the determining the changed manufacturing process, an identifying of similarities between the historical manufacturing data and the target manufacturing data and/or an identifying of similarities between the historical product data and the target product data are conducted.

5. The method according to claim 4, wherein, for the identifying of similarities, a change object list of changes between the historical manufacturing process data and the target manufacturing process data and/or between the historical product data and target product data is generated.

6. The method according to claim 1, wherein, for the identifying of similarities, at least one of following similarity scoring method is carried out:
Eigenvector Distance;
Graph Edit Distance; and
Mean Levenshtein Distance of Graph Labels.

7. The method according to claim 1, wherein an effort list, a risk list, and/or a cost list of the changed manufacturing process are generated.

8. The method according to claim 1, wherein, for the determining the changed manufacturing process following additional steps are conducted:
generating of a preselected list with preselected manufacturing processes; and
selecting of the changed manufacturing process from the preselected list with preselected manufacturing processes are executed.

9. The method according to claim 1, wherein a machine learning tool is used.

10. An apparatus with a computer system for executing of the method according to claim 1, wherein
the computer system comprises at least one insighter engine for the executing of the method; and
the insighter engine comprises at least one data providing tool for providing of the basic data.

11. The method according to claim 1, wherein the changed process is in an automotive industry.

12. (canceled)
